(19) United States
(12) Patent Application Publication
(10) Pub. No.: US 2014/0226500 A1
(43) Pub. Date: Aug. 14, 2014

(54) CONDITIONAL CHANNEL MEASUREMENT OPERATIONS BASED ON RESOURCE AVAILABILITY

(71) Applicant: QUALCOMM INCORPORATED, San Diego, CA (US)

(72) Inventors: Yan Zhou, San Diego, CA (US); George Cherian, San Diego, CA (US); Hemanth Sampath, San Diego, CA (US)

(73) Assignee: QUALCOMM Incorporated, San Diego, CA (US)

(21) Appl. No.: 13/766,439

(22) Filed: Feb. 13, 2013

(51) Int. Cl. H04W 24/10

(52) U.S. Cl. CPC H04W 24/10
USPC 370/252

(57) ABSTRACT

In a conditional channel measurement operation, an apparatus may determine how to invoke a channel measurement operation based on whether one or more measurement operation conditions are met. A channel measurement operation may involve measuring conditions on a channel, reporting results of a channel measurement, or some other operation related to measurement of a channel. A measurement operation condition may relate to resource availability, a measurement timing criterion, or some other condition used to control how a channel measurement-related operation is conducted. In some aspects, conditional channel measurement operations involve determining whether, when, and the manner in which channel conditions are measured and/or reported. For example, an apparatus may conduct a measurement and/or report the results of a measurement at a time or in a manner that mitigates impact on channel traffic and/or at least one resource.

### CROSS-REFERENCE TO RELATED APPLICATION

This application is related to concurrently filed and commonly owned U.S. Patent Application No. _____, entitled “CONDITIONAL CHANNEL MEASUREMENT OPERATIONS BASED ON MEASUREMENT TIMING CRITERION,” and assigned Attorney Docket No. 130162U2, the disclosure of which is hereby incorporated by reference herein.

### BACKGROUND

1. Field

This application relates generally to wireless communication and more specifically, but not exclusively, to conducting channel measurement operations at a wireless apparatus.

2. Introduction

In wireless networks, conditions on different channels may be monitored to identify a preferred channel for communication. For example, an access point (e.g., IEEE 802.11-based access point) that is capable of operating of different channels may regularly acquire channel condition information for those channels to determine whether the access point should switch to a different channel. As a specific example, the access point may switch channels if the load on another channel is lower than the load on the channel currently being used.

Channel condition information also may be used to determine whether to handover an access terminal (e.g., mobile station) from one channel to another channel. For example, an access terminal may monitor channel conditions on different channels and elect to initiate handover to an access point a different channel if the load on the other channel is lower than the load on the channel currently being used by the access terminal

In wireless networks such as IEEE 802.11-based networks (commonly referred to as Wi-Fi), an access point instructs a station (STA) to conduct radio measurements (e.g., to determine the loading on different channels) and report the results of the measurements. In practice, however, these measurement and reporting operations may adversely affect operations at the stations (e.g., affect the ability of the station to handle its application processing) and affect traffic on the channels (e.g., interfere with application traffic). This is particularly the case when the measurement and reporting are assigned higher priority than other operations and/or traffic.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to conditional (e.g., opportunistic) channel measurement operations conducted by an apparatus. For example, an access terminal (e.g., an IEEE 802.11-based STA) may determine how to invoke a channel measurement operation based on whether one or more measurement operation conditions are met.

In some cases, a channel measurement operation relates to measuring conditions (e.g., signal and/or traffic conditions) on a channel. An apparatus may measure channel conditions, for example, by analyzing received signals to determine at least one of: characteristics of the signals (e.g., signal strength), information included in the signals (e.g., messages), or an amount of time the signals exist on the channel (e.g., the percentage of time the channel is busy).

In some cases, a channel measurement operation relates to reporting results of a channel measurement. For example, an apparatus may send a message that indicates the channel load measured by the access terminal, signal characteristics measured by the access terminal, and so on.

In some aspects, conditional channel measurement operations involve an access terminal determining how (e.g., whether and/or when) to measure channel conditions and/or report the results of a measurement. For example, an apparatus may conduct a measurement and/or report the results of a measurement at a time or in a manner that reduces negative impact on channel traffic and/or other resources (e.g., one or more resources of the apparatus).

In some aspects, an apparatus may determine an optimum manner of conducting a channel measurement based on one or more channel measurement conditions. Examples of such conditions include: 1) the current or expected traffic on the channel(s); 2) battery resources at the apparatus; 3) the amount of time available at the apparatus for conducting a measurement; 4) the amount of time that has passed since the last measurement; and 5) a defined measurement end time.

In some aspects, an apparatus may determine an optimum manner of reporting the results of a channel measurement based on one or more reporting conditions. Examples of such conditions include: 1) availability of a data frame for piggyback transmission; 2) the total size of accumulated reports; 3) channel load; 4) availability of the next contention-free transmission; and 5) a defined report end time.

Any of the above measurement operation conditions used for measurement and/or reporting may be defined by an apparatus that conducts the channel measurement operation (e.g., an access terminal) or may be defined by an apparatus that requests the channel measurement operation (e.g., an access point). In the latter case, an indication of each measurement operation condition may be sent to the access terminal via a measurement request.

In some implementations, an apparatus determines how to conduct an operation associated with measurement of a condition of at least one channel based on at least one indication included in a channel measurement request received by the apparatus. For example, an access point may send to an access terminal a specific request to conduct a conditional channel measurement operation (e.g., as indicated by a corresponding flag in a measurement request) in cases where the access point does not need the channel measurement operation to be conducted expediently. Thus, the access terminal may determine, based on an indication in the request, to commence a conditional channel measurement operation rather than a conventional, high-priority channel measurement operation.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several sample aspects of a communication system employing conditional channel measurement operations;

FIG. 2 is a flowchart of several sample aspects of conditional channel measurement operations;

FIG. 3 is a flowchart of several sample aspects of operations where invocation of a channel measurement is based on availability of at least one resource;

FIG. 4 is a flowchart of several sample aspects of operations where invocation of transmission of a channel measurement report is based on availability of at least one resource;

FIG. 5 is a flowchart of several sample aspects of operations where invocation of a channel measurement is based on a time selected according to at least one measurement timing criterion;

FIG. 6 is a flowchart of several sample aspects of operations where invocation of transmission of a channel measurement report is based on a time selected according to at least one measurement timing criterion;

FIG. 7 is a flowchart of several sample aspects of operations relating to a request for a channel measurement operation;

FIG. 8 is a simplified block diagram of several sample aspects of components that may be employed in communication nodes;

FIG. 9 is a simplified block diagram of several sample aspects of communication components; and

FIGS. 10-14 are simplified block diagrams of several sample aspects of apparatuses configured to conduct conditional channel measurement operations as taught herein.

In accordance with common practice, the features illustrated in the drawings are simplified for clarity and are generally not drawn to scale. That is, the dimensions and spacing of these features are expanded or reduced for clarity in most cases. In addition, for purposes of illustration, the drawings generally do not depict all of the components that are typically employed in a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a method of communication comprises: receiving, by an apparatus, a request to measure a condition of at least one channel; determining, by the apparatus, availability of at least one resource for measuring the condition of the at least one channel; and invoking, by the apparatus, the measurement of the condition based on the receipt of the request and further based on the availability of the at least one resource. In addition, in some aspects, the determination of the availability of the at least one resource comprises determining an amount of data traffic expected to be received by the apparatus.

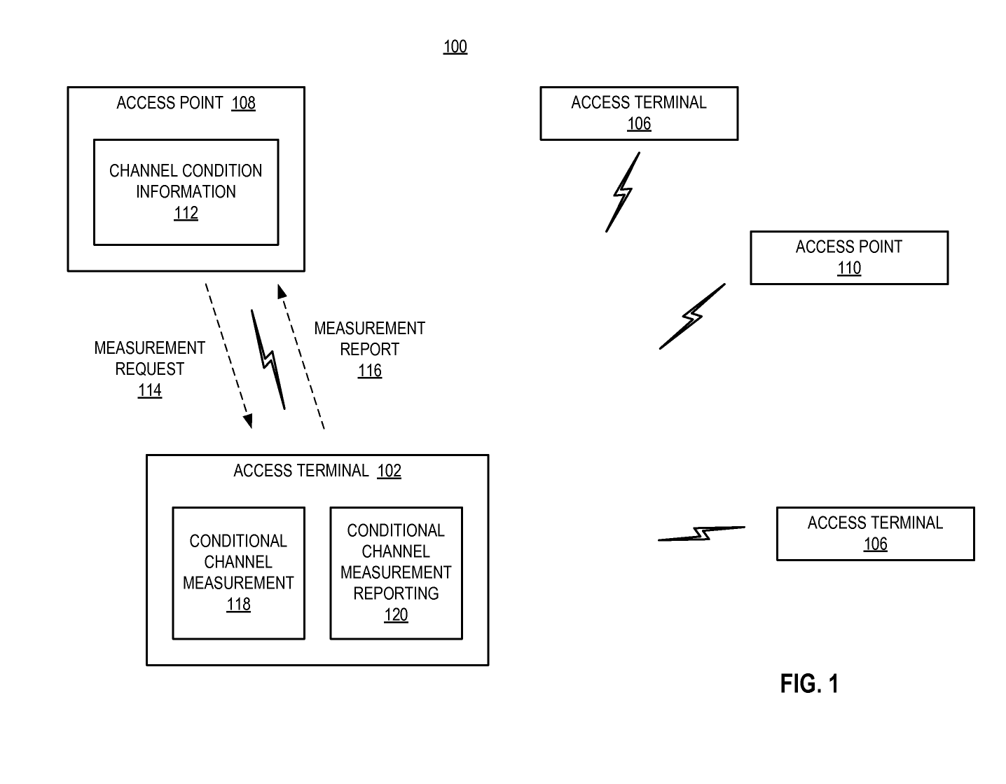

FIG. 1 illustrates several nodes of a sample communication system 100 (e.g., a portion of a communication network). For illustration purposes, various aspects of the disclosure will be described in the context of one or more access points and one or more access terminals that communicate with one another. It should be appreciated, however, that the teachings herein may be applicable to other types of apparatuses or other similar apparatuses that are referenced using other terminology. For example, in various implementations access points may be referred to or implemented as base stations, radio base stations, and so on, while access terminals may be referred to or implemented as stations (e.g., STAs), mobile stations, user equipment (UEs), and so on.

Access points in the system 100 provide access to one or more services (e.g., network connectivity) for one or more access terminals that may be installed within or that may roam throughout coverage areas provided by the system 100. For example, at various points in time an access terminal 102 may connect to an access point 108, an access point 110, or some access point in the system 100 (not shown). Similarly, the access terminal 104 and the access terminal 106 may connect to these or other access points in the system 100. Each of these access points may communicate with one or more network entities (not shown) to facilitate wide area network connectivity.

The access points and the access terminals in the system are each capable of operating on different channels. For example, in an IEEE 802.11-based system, an access point (and, hence, an access terminal) may operate on channel 1, or channel 2, or channel 3, etc., at a given point in time. Moreover, in general, an access point (and, hence, an access terminal) may switch between any of these supported channels. As used herein, the term channel refers to different aspects of a radiofrequency communication medium (e.g., defined by different frequency ranges, different codes, different hopping sequences, and so on). In addition, as used herein, the term IEEE 802.11-based refers to any of the IEEE 802.11 standards (e.g., 802.11a, 802.11b, etc.).

To facilitate channel selection/or and handover of access terminals, conditions on the different channels may be monitored to identify a preferred channel for communication. Channel conditions may relate to, for example, load, traffic, interference, signal strength, or other quality metrics.

Each access point in the system 100 acquires channel condition information 112 for those channels supported by the access point. For example, at various points in time (e.g., periodically), the access point 108 may issue a measurement request 114 that is transmitted to each access terminal currently being served by the access point 108. In this way, each access terminal will conduct channel measurements on behalf of the access point and report the results of the channel measurements back to the access point as indicated by a measurement report 116. The access point 108 may thus use a measurement report 116 received from the access terminal 102, along with measurement reports from other access terminals, to determine the condition of each channel.

In accordance with the teachings herein, the access terminals and access points in the system 100 support conditional channel measurements. For example, an access point may issue different types of measurement requests depending on how urgently the access point needs the measurement report information.

For situations where an access point needs the feedback quickly, the access point may issue a conventional high-priority measurement request. For example, in an IEEE 802.11-based system, a conventional measurement request may be given higher priority than data traffic. Thus, an access terminal that receives such a request will conduct the measurement and respond relatively quickly.

In contrast, for situations where an access point does not need the feedback as quickly, the access point may issue a conditional (e.g., opportunistic) measurement request. A conditional measurement request may be indicated, for example, through the use of a dedicated type of request, through the use of a flag (e.g., a settable bit) in a request message, or through the use of some other manner of indicating that a conditional measurement is being requested.

Upon receiving a request for a conditional measurement, an access terminal invokes a channel measurement operation based on whether a measurement operation condition is (or measurement operation conditions are) met. For example, an apparatus may conduct a measurement operation at a time or in a manner that attempts to reduce impact on channel traffic and/or other resources (e.g., one or more resources of the apparatus). In this way, use of a conditional channel measurement scheme may mitigate adverse effects that the corresponding channel measurement operations may otherwise have on the system 100.

As mentioned above, in some aspects, a channel measurement operation may relate to measuring conditions (e.g., signal and/or traffic conditions) on a channel. Accordingly, as shown in FIG. 1, an access terminal may include a conditional channel measurement component 118 that determines how to measure channel conditions depending on whether one or more measurement conditions are met. As used herein, the term measurement condition refers to a specific type of measurement operation condition that relates to measuring a channel (e.g., as opposed to reporting a measurement).

A channel measurement may be controlled in various ways. For example, a channel measurement request may be rejected (e.g., explicitly rejected or simply ignored) if a measurement condition is not met. As another example, the timing of the channel measurement may depend on whether the measurement condition is met. Here, a channel measurement may be delayed until such time that the measurement condition is met. As yet another example, the manner in which a measurement is conducted may depend on whether a measurement condition is met. Here, the number of measurements taken may be reduced, the duration of each measurement may be reduced, or the measurements may be conducted in some other manner that reduces resource usage (e.g., certain channels are not measured, the receiver is configured to use less power, etc.).

A variety of measurement conditions may be defined to control channel measurements. One or more of these measurement conditions may be used to control a given channel measurement. Several examples follow.

An access terminal may control channel measurements based on traffic (e.g., data traffic) at the access terminal For example, channel measurements may be allowed if the access terminal does not have data to send and/or if there is no data to be received by the access terminal. As a specific example, a channel measurement may be invoked in cases where the access terminal is not being paged in the downlink and/or there is no data buffered at the access terminal for transmission on the uplink. Conversely, if there is data to be sent from or received at the access terminal, the access terminal may reject channel measurement requests or delay or otherwise restrict channel measurements.

An access terminal may control channel measurements based on available power at the access terminal For example, an access terminal may allow a channel measurement only if it has sufficient battery life. Thus, if the available battery power is at or below a threshold level, the access terminal may reject channel measurement requests or delay or otherwise restrict channel measurements until the battery is recharged.

An access terminal may control channel measurements based on the amount of time that the access terminal has available to conduct a channel measurement. For example, an available measurement period for an access terminal may indicate the amount of free time the access terminal has before it is required to do some other operation. Thus, if the available measurement period is greater than or equal to a threshold (e.g., indicating that the access terminal has sufficient time to conduct a channel measurement), the access terminal may conduct a channel measurement. Otherwise, the access terminal may reject channel measurement requests or delay or otherwise restrict channel measurements until such time that there is a sufficient available measurement period.

An access terminal may control channel measurements based on the time since the last channel measurement. For example, an access terminal may control the timing of channel measurements to avoid conducting channel measurements too frequently. Thus, if the time since the last channel measurement was sent is greater than or equal to a threshold (e.g., indicating that sufficient time has passed since the access terminal conducted the last channel measurement), the access terminal may conduct a channel measurement. Otherwise, the access terminal may reject channel measurement requests or delay or otherwise restrict channel measurements until sufficient time has passed since the last channel measurement.

An access terminal may control channel measurements based whether a defined measurement end time has arrived. As its name indicates, the end time specifies the time by which a channel measurement must end (e.g., be completed). Thus, if a channel measurement can be completed before the measurement end time, the access terminal may conduct the channel measurement. Otherwise, the access terminal may reject channel measurement requests or delay or otherwise restrict (e.g., shorten) channel measurements until another measurement end time is specified.

The measurement end time may be defined by the access terminal or the requesting access point. In the latter case, the access point may include an indication of the measurement end time in the request or in some other message (e.g., a configuration message) sent to the access terminal

As mentioned above, in some aspects, a channel measurement operation may relate to reporting results of a channel measurement. Accordingly, as shown in FIG. 1, an access terminal may include a conditional channel measurement reporting component 120 that determines how to report the results of a channel measurement depending on whether a reporting condition is (or reporting conditions are) met. As used herein, the term reporting condition refers to a specific type of measurement operation condition that relates to reporting the results of a channel measurement (e.g., as opposed to measuring a channel).

Channel measurement reporting may be controlled in various ways. For example, if a measurement condition is not met, a measurement request may be rejected (e.g., explicitly rejected or simply ignored) whereby a report is never sent back to the requester. As another example, the timing of the reporting may depend on whether the reporting condition is met. Here, reporting may be delayed until such time as the reporting condition is met. As yet another example, the manner in which reporting is conducted may depend on whether the reporting condition is met. Here, the number of channel measurement reports may be reduced, the duration of each channel measurement report may be reduced, or the channel measurements may be reported in some other manner that reduces resource usage (e.g., different coding is used to transmit the channel measurement report, the transmitter is configured to use less power, etc.).

A variety of reporting conditions may be defined to control channel measurement reporting. One or more of these reporting conditions may be used to control a given channel measurement report. Several examples follow.

An access terminal may control channel measurement reporting based on the availability of a data frame for piggybacking the report. For example, an access terminal may wait to report the results of a channel measurement until the next data packet transmission. In this way, the access terminal can piggyback the channel measurement report with the data packet, thereby saving channel access and overhead resources.

An access terminal may control channel measurement reporting based on the total size of accumulated channel measurement reports. For example, rather than send a channel measurement report as each channel measurement is conducted, the access terminal may accumulate the channel measurement reports and send the accumulated channel measurement reports in a single message. In this way, the access terminal may conserve resources (e.g., relating to channel access) that would otherwise be used to send individual channel measurement report messages. Accordingly, the access terminal may wait to send the accumulated channel measurement reports until the size of the accumulated reports is greater than or equal to a threshold.

An access terminal may control channel measurement reporting based on the load (e.g., the percentage of time the resource is being used) on a channel. For example, if the load on the channel used for transmitting channel measurement reports is sufficiently low (e.g., less than or equal to a threshold), the access terminal will send channel measurement reports. However, if the channel load is relatively high (e.g., greater than or equal to a threshold), the access terminal may not send channel measurement reports or may otherwise restrict channel measurement reports. Alternatively, the access terminal may elect to delay channel measurement reporting until such time as the channel load is sufficiently low.

An access terminal may control channel measurement reporting based on when a contention-free period is next available on the resource (e.g., channel) used for sending the channel measurement reports. For example, an access terminal may wait to report the results of a channel measurement until the next contention-free period. Contention-free periods may be provided, for example, on the uplink through the use of reverse direction protocol/power save multi-poll (RDP/PSMP).

An access terminal may control channel measurement reporting based on traffic (e.g., data traffic) at the access terminal For example, channel reporting may be allowed if the access terminal does not have data to send and/or if there is no data to be received by the access terminal. As a specific example, a channel measurement report may be sent in cases where the access terminal is not being paged in the downlink and/or there is no data buffered for transmission on the uplink. Conversely, if there is data to be sent from or received at the access terminal, the access terminal may not send channel measurement reports or may delay or otherwise restrict channel measurement reports.

An access terminal may control channel measurement reporting based on available power at the access terminal For example, an access terminal may allow channel measurement reporting only if the access terminal has sufficient battery life. Thus, if the available battery power is at or below a threshold level, the access terminal may not send the channel measurement reports or may delay or otherwise restrict channel measurement reports until the battery is recharged.

An access terminal may control channel measurement reporting based on the amount of time that the access terminal has available to conduct a channel measurement report. For example, an available reporting period for an access terminal may indicate the amount of free time the access terminal has before it is required to do some other operation. Thus, if the available reporting period is greater than or equal to a threshold (e.g., indicating that the access terminal has sufficient time to send a channel measurement report), the access terminal may send a channel measurement report. Otherwise, the access terminal may not send channel measurement reports or may delay or otherwise restrict channel measurement reports until such time that there is a sufficient available reporting period.

An access terminal may control channel measurement reporting based on the time since the last channel measurement report. For example, an access terminal may control channel measurement report timing to avoid sending channel measurement reports too frequently. Thus, if the time since the last channel measurement report was sent is greater than or equal to a threshold (e.g., indicating that sufficient time has passed since the access terminal sent the last channel measurement report), the access terminal may send a channel measurement report. Otherwise, the access terminal may not send the channel measurement report or may delay or otherwise restrict the channel measurement report until sufficient time has passed since the last channel measurement report.

An access terminal may control channel measurement reporting based whether a defined report end time has arrived. This end time specifies the time by which a channel measurement report operation must end (e.g., be completed). Thus, if the channel measurement report operation can be completed before the report end time, the access terminal may send the channel measurement report. Otherwise, the access terminal may reject channel measurement requests or otherwise delay or restrict (e.g., shorten) channel measurement reports until another report end time is specified.

The report end time may be defined by the access terminal or the requesting access point. In the latter case, the access point may include an indication of the report end time in the request or in some other message (e.g., a configuration message) sent to the access terminal

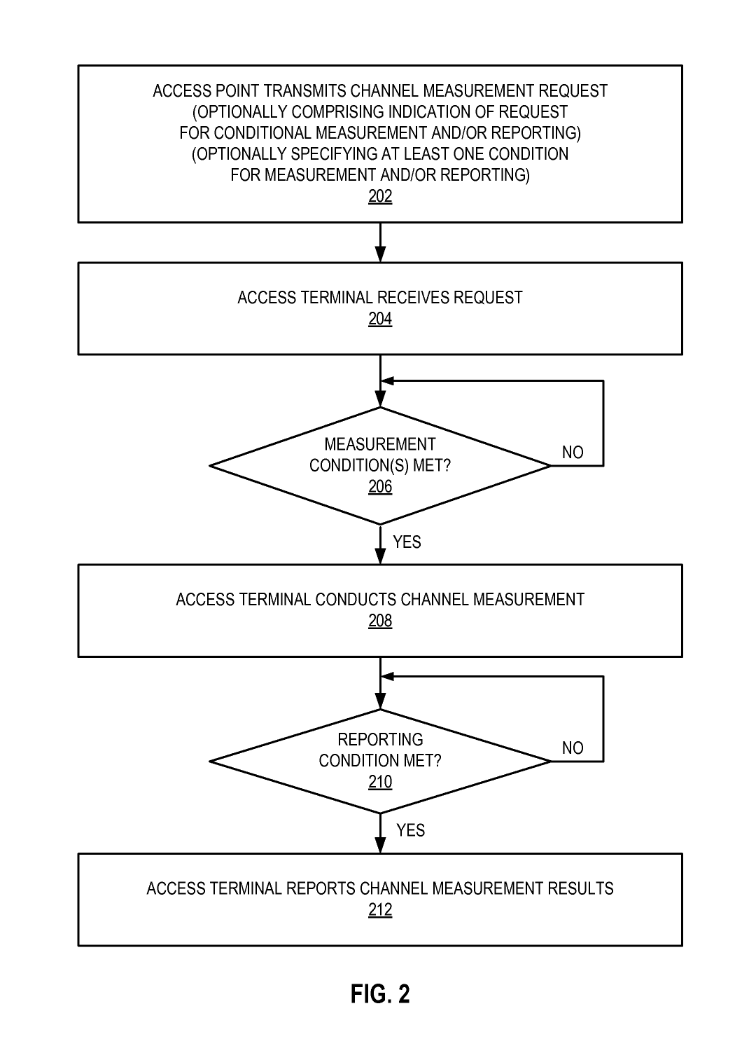

FIG. 2 illustrates an example of conditional measurement operations in accordance with the teachings herein. For purposes of illustration, the operations of FIG. 2 (or any other operations discussed or taught herein) may be described as being performed by specific components. For example, the operations of FIG. 2 are described for the case where an access point requests an access terminal to conduct a channel measurement. However, these operations may be performed by other types of components and may be performed using a different number of components in other implementations. Also, it should be appreciated that one or more of the operations described herein may not be employed in a given implementation. For example, one entity may perform a subset of the operations and pass the result of those operations to another entity.

As represented by block 202 of FIG. 2, at some point in time, an access point transmits a channel measurement request. This message may request, for example, that channel conditions be measured on one or more channels (e.g., identified in the request).

The access terminal may transmit the request in various ways. In some cases, the access point transmits a request message to each access terminal currently being served by the access point. In some cases, the access point broadcasts a request message.

In some cases, the request comprises an indication that the request is requesting conditional (e.g., opportunistic) measurement and/or reporting. This indication may be explicit or implicit.

For example, a request may explicitly include one or more flags (e.g., bits) that may be set to specify conditional measurement, conditional reporting, or both. In such a case, the absence of the flag(s) being set may indicate a request for conventional (e.g., high-priority) measurement and/or reporting.

As another example, the request may comprise a type of request message that is dedicated for conditional measurement and/or reporting. Hence, the type of message implicitly indicates that conditional measurement and/or reporting is being requested. In such an implementation, a different type of request (e.g., a conventional IEEE 802.11-based request) may be used to request conventional measurement and reporting.

In some cases, the request issued by the access point specifies at least one condition for the measurement and/or the reporting. Several examples of measurement and/or reporting conditions follow. A request message may specify measurement timing (e.g., the message may include an indication of measurement end time). A request message may specify report timing (e.g., the message may include an indication of report end time). A request message may indicate at least one resource to be taken into account when invoking a measurement operation (e.g., the message specifies at least one resource to be used for a resource availability test). A request message may include at least one measurement timing criterion to be taken into account when invoking a measurement operation.

As represented by block 204, an access terminal receives the request transmitted by the access point. As discussed above, based on the request, the access terminal will be able to determine that the request is for conditional measurement and/or reporting. For purposes of explanation, the discussion that follows assumes that both conditional measurement and conditional reporting are used. It should be appreciated, however, that one of these channel measurement operations might not be performed in a conditional manner in some implementations (e.g., the non-conditional operation is performed as soon as possible).

As represented by block 206, the access terminal determines whether each measurement condition is met. For example, as discussed above, the access terminal may determine whether there is pending traffic, whether the access terminal has sufficient battery resources, and so on.

In the example of FIG. 2, in the event at least one measurement condition is not met, the access terminal delays the measurement until such time as every condition is met. As discussed above, other implementations may take other actions in the event at least one measurement condition is not met. For example, the access terminal may reject the measurement request or the access terminal may adapt the channel measurement procedure (e.g., to reduce any negative impact on traffic and/or other resources).

As represented by block 208, in the event each measurement condition is met at block 206, the access terminal conducts the requested channel measurement(s). For example, the access terminal may measure channel conditions on one or more channels (e.g., as identified by the request).

A variety of channel conditions may be measured. Examples of channel conditions include: load on a channel (e.g., the percentage of time that the channel is being used); measured signal power (e.g., RSSI), channel quality, channel noise, traffic types, user types, and so on.

As represented by block 210, after the channel measurement is complete, the access terminal determines whether each reporting condition is met. For example, as discussed above, the access terminal may determine when the next data frame is available for piggybacking a report, whether channel load is sufficiently low, and so on.

In the example of FIG. 2, in the event at least one reporting condition is not met, the access terminal delays transmitting the report until such time as every condition is met. As discussed above, other implementations may take other actions in the event each reporting conditions is not met. For example, the access terminal may reject the measurement request or the access terminal may adapt the measurement report procedure (e.g., to reduce any negative impact on traffic and/or other resources).

As represented by block 212, in the event each reporting condition is met at block 210, the access terminal reports the results of the channel measurement(s). For example, the access terminal may transmit one or more measurement reports that identify each channel and include information indicative of the condition of that channel (e.g., loading, RSSI, etc.).

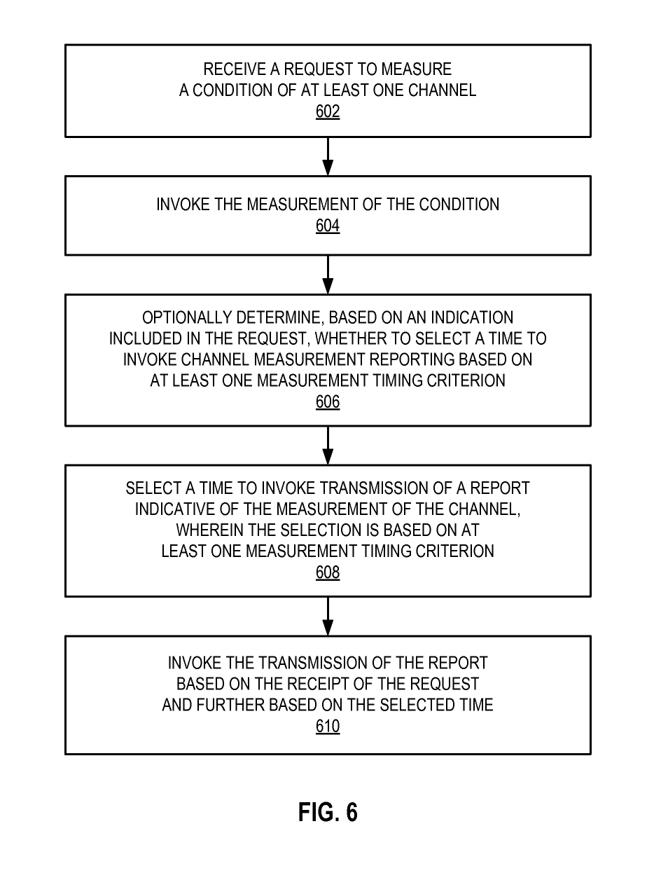

With the above in mind, FIGS. 6 illustrate examples of additional operations that may be employed in conjunction with invoking channel measurement operations in accordance with the teachings herein. These operations may be performed by an apparatus such as an access terminal (e.g., an IEEE 802.11-based STA) or by some other entity that conducts channel measurements.

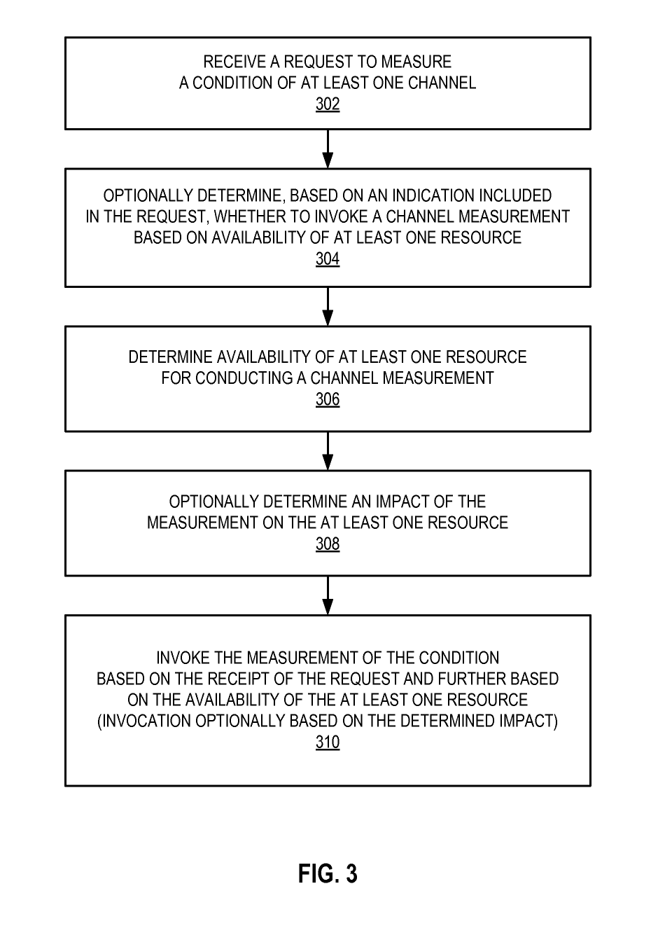

Referring initially to FIG. 3, this flowchart relates to invoking channel measurement based, at least in part, on resource availability.

As represented by block 302, at some point in time, a request to measure a condition of a channel is received. As discussed herein, this request may comprise information that is used to invoke or otherwise perform the channel measurement operation. For example, the request may specify at least one resource as discussed herein.

In some scenarios, the request may indicate that a channel measurement is to be invoked in a conditional manner (e.g., an opportunistic manner). As represented by block 304, a determination as to whether to invoke a channel measurement based on availability of at least one resource is, in some cases, based on the type of request and/or information included in the request. For example, an indication included in the request may specify that a conditional channel measurement is to be based on resource availability. Block 304 is optional in the sense that some implementations may not need to make such a decision or may make this decision in a different way. As an example of the former case, an apparatus may be configured to always invoke a channel measurement based on resource availability. As an example of the later case, an indication that a channel measurement is to be based on resource availability may be received in some other manner (e.g., via a configuration message).

The resource(s) used for the invocation of the channel measurement may take various forms. For example, in some cases, the at least one resource comprises at least one resource of the apparatus (e.g., battery power, available time for performing an operation, processing resources, radio resources, etc.). As another example, in some cases, the at least one resource comprises at least one resource of one or more of the at least one channel (e.g., time slots, frequency spectrum, spare capacity, etc.).

As represented by block 306, a determination is made regarding the availability of at least one resource for conducting a channel measurement. Thus, in this example, an apparatus may take action, by itself, to determine the availability of one or more specified resources, rather than have some other entity make this determination. As discussed herein, the resource(s) to be checked may be specified by the apparatus that is to conduct the measurement (e.g., an access terminal, etc.), by the apparatus that requested the measurement (e.g., an access point, a network entity, etc.), or by some other entity (e.g., a network entity, etc.).

The availability of one designated resource or multiple designated resources may be determined at block 306 depending on the requirements of a given implementation. As mentioned above, the resource(s) of interest may take various forms. Several specific examples of resource availability follow. In some cases, the availability of at least one resource relates to an amount of data traffic at the apparatus. For example, the determination of the availability of the at least one resource may comprise determining an amount of data traffic expected to be received by the apparatus and/or expected to be transmitted by the apparatus. In some cases, the availability of at least one resource relates to availability of a battery resource of the apparatus. In some cases, the availability of at least one resource relates to availability of a period of time for conducting the channel measurement. In some cases, the availability of at least one resource relates to traffic load on one or more of the at least one channel.

As represented by block 308, in some implementations, a determination is made regarding any impact the channel measurement may have on the at least one resource. For example, an apparatus may determine how much (e.g., what percentage) of the battery power, processing power, radio resources, or other resources of the apparatus will be used to conduct the channel measurement. As discussed below, this information may be used to determine how to invoke a channel measurement.

As represented by block 310, the measurement of the condition is invoked based on the receipt of the request and further based on the availability of the at least one resource. For example, upon receipt of the request at block 302 and upon determining at block 306 that each requisite resource is available, the apparatus may commence the requested channel measurement.

In some implementations, the invocation of the channel measurement is further based on the impact determined at block 308. For example, if an apparatus determines that the requested channel measurement will consume too much (e.g., too high of a percentage) of a limited resource of the apparatus, the apparatus may elect to not invoke the channel measurement, or may elect to adapt the channel measurement in some manner that reduces the impact on the resource (e.g., invoke the operation at a later time, in a manner that uses less power, etc.).

As a result of the invocation of block 310, the access terminal measures the condition of the channel(s). In some aspects, this involves: receiving signals on at least one channel, and measuring the condition of the at least one channel by processing the received signals. This processing may involve, for example, one or more of: determining channel loading, determining RSSI, decoding a message carried by the signals, or determining some other characteristic(s) associated with the channel(s).

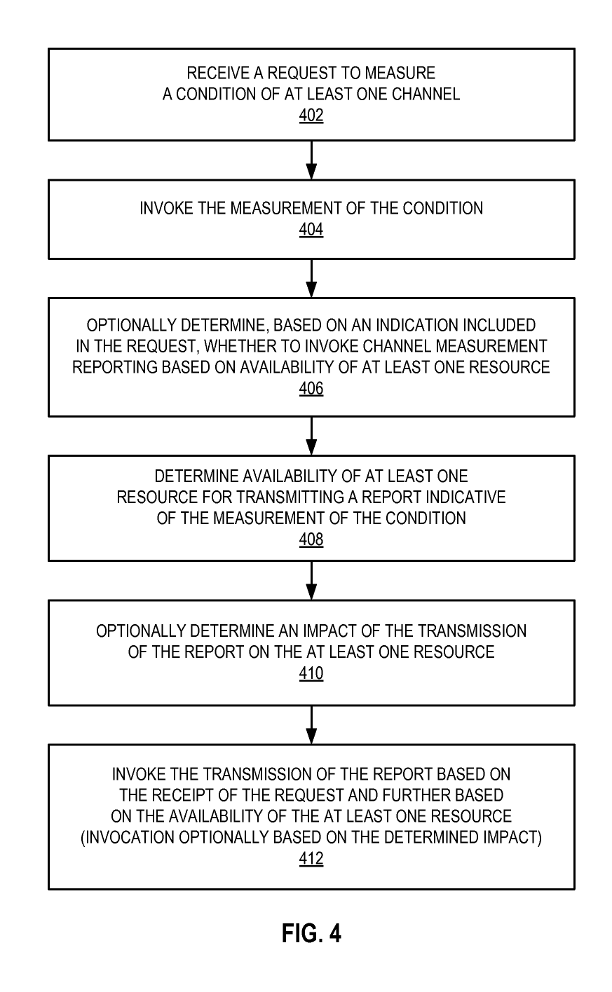

Referring now to FIG. 4, this flowchart relates to invoking channel measurement reporting based, at least in part, on resource availability.

Block 402 involves receiving a request to measure a condition of at least one channel. Thus, the operations of block 402 may generally correspond to the operations of block 302 described above.

As represented by block 404, the measurement of the condition is invoked as a result of receiving the request at block 402. As discussed above, this may involve, for example, determining one or more characteristics (e.g., loading, RSSI, etc.) associated with the channel(s).

In some scenarios, the request received at block 402 may indicate that channel measurement reporting is to be invoked in a conditional manner (e.g., an opportunistic manner). As represented by block 406, a determination as to whether to invoke channel measurement reporting based on availability of at least one resource is, in some cases, based on the type of request and/or information included in the request. For example, an indication included in the request may specify that conditional channel measurement reporting is to be based on resource availability. In a similar manner as discussed above for block 304, the operations of block 406 are optional given that in various implementations conditional channel measurement reporting may be implicit, requested in some other manner, or invoked in some other way.

As represented by block 408, a determination is made regarding the availability of at least one resource for transmitting a report indicative of the measurement of the condition. With regard to determining resource availability, the operations of block 408 may generally correspond to the operations of block 306 described above.

The resource(s) taken into consideration here may take various forms. For example, the resource(s) checked at block 408 may comprise one or more of the resource(s) discussed above in conjunction with FIG. 3. Several specific examples of resource availability follow. In some cases, the availability of at least one resource relates to availability of a battery resource of the apparatus. In some cases, the availability of at least one resource relates to availability of a scheduled data frame transmission for piggybacking of a channel measurement report. In some cases, the availability of at least one resource relates to availability of a contention-free time for transmitting a channel measurement report. In some cases, the availability of at least one resource relates to availability of a period of time for preparing and/or transmitting the report. In some cases, the determination of the availability of at least one resource comprises determining loading on a channel used by the apparatus (e.g., at least one channel over which the report is transmitted).

As represented by block 410, in some implementations, a determination is made regarding any impact the transmission of the report may have on the at least one resource. For example, an apparatus may determine how much (e.g., what percentage) of the battery power, processing power, radio resources, or other resources of the apparatus will be used to prepare and/or transmit the report. As discussed below, this information may be used to determine how to invoke the transmission of the report.

As represented by block 412, the transmission of the report is invoked based on the receipt of the request and further based on the availability of the at least one resource. For example, upon receipt of the request at block 402 and upon determining at block 408 that each requisite resource is available, the apparatus may commence the transmission of requested channel measurement report.

In some implementations, the invocation of the transmission of the report is further based on the impact determined at block 410. For example, if an apparatus determines that responding to a request for a channel measurement report will consume too much (e.g., too high of a percentage) of a limited resource of the apparatus, the apparatus may elect to not invoke channel measurement reporting, or may elect to adapt the channel measurement reporting in some manner that reduces the impact on the resource (e.g., invoke the operation at a later time, in a manner that uses less power, etc.).

In implementations where measurement report information is accumulated for transmission back to the requester, the channel measurement operation conditionally invoked at block 412 may involve transmitting an aggregate channel measurement report. In this case, upon generating a report indicative of a given channel measurement, the report is accumulated with at least one other report. Subsequently, the invocation of the channel measurement operation is based on a size of the accumulated reports, the time since the last aggregate report was sent, the number of accumulated reports, or some combination of these or other factors. For example, an aggregate report may be sent once the size of the accumulated reports meets or exceeds a threshold size (e.g., 10 Kbits). As another example, an aggregate report may be sent once the number of accumulated reports meets or exceeds a threshold size (e.g., 20 reports). As yet another example, an aggregate report may be sent once the time since the transmission of the last set of accumulated reports meets or exceeds a threshold time duration (e.g., 100 milliseconds).

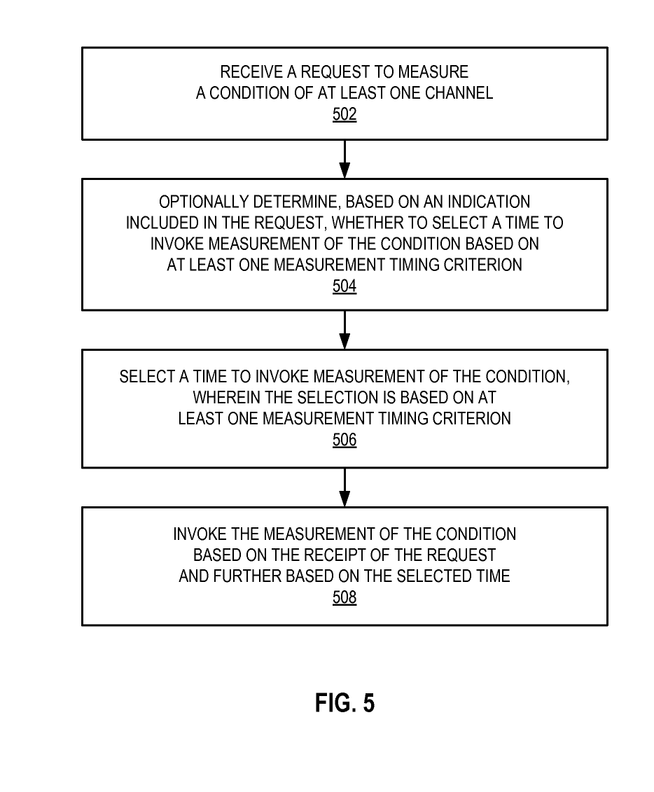

FIG. 5 relates to invoking channel measurement based, at least in part, on at least one measurement timing criterion.

Block 502 involves receiving a request to measure a condition of a channel. Thus, the operations of block 502 may generally correspond to the operations of block 302 described above.

In some scenarios, the request may indicate that a channel measurement is to be invoked in a conditional manner (e.g., an opportunistic manner). As represented by block 504, a determination as to whether to select a time to invoke measurement of the condition based on the at least one measurement timing criterion is, in some cases, based on the type of request and/or information included in the request. For example, an indication included in the request may specify that a conditional channel measurement is to be invoked at a time that is based on at least one measurement timing criterion. Block 504 is optional in the sense that some implementations may not need to make such a decision or may make this decision in a different way. As an example of the former case, an apparatus may be configured to always invoke a channel measurement at a time that is based on at least one measurement timing criterion. As an example of the later case, an indication that a channel measurement is to be invoked at a time that is based on at least one measurement timing criterion may be received in some other manner (e.g., via a configuration message).

As represented by block 506, a time to invoke the measurement of the condition is selected based on at least one measurement timing criterion. Thus, in the implementation of FIG. 5, an apparatus may select, by itself, the time at which the channel measurement is invoked. In other words, the apparatus that conducts the channel measurement is not told (e.g., by the requester) what time to invoke the channel measurement. Rather, the apparatus decides this timing on its own based, at least in part, on whether each measurement timing criterion is met.

A measurement timing criterion used for the invocation of the channel measurement may take various forms. In some cases, the at least one measurement timing criterion relates to a time since a last channel measurement performed by the apparatus. In some cases, the at least one measurement timing criterion relates to an end time for the measurement of the condition. In some cases, the at least one measurement timing criterion relates to timing of an available measurement period for the apparatus.

A measurement timing criterion may be defined in various ways. For example, the measurement timing criterion to be used for an opportunistic channel measurement may, in various implementations, be specified by the apparatus that is to conduct the measurement (e.g., an access terminal, etc.), by the apparatus that requested the measurement (e.g., an access point, a network node, etc.), or by some other entity (e.g., a network entity, etc.). Similarly, any parameter to be used in conjunction with a given type measurement timing criterion may, in various implementations, be defined by the apparatus conducting the measurement, by the requester, or by some other entity.

As represented by block 508, the measurement of the condition is invoked based on the receipt of the request and further based on the time selected at block 506. Thus, upon receipt of the request at block 502, the apparatus may commence the requested channel measurement at the selected time. For example, invocation of the channel measurement may be delayed until the period of time since the last measurement meets or exceeds a threshold time period. As another example, invocation of the channel measurement may be expedited if a measurement end time cannot otherwise be met.

FIG. 6 relates to invoking channel measurement reporting based, at least in part, on at least one measurement timing criterion.

Block 602 involves receiving a request to measure a condition of at least one channel. Thus, the operations of block 602 may generally correspond to the operations of block 402 described above.

As represented by block 604, the measurement of the condition is invoked as a result of receiving the request at block 602. As discussed above, this may involve, for example, determining one or more characteristics (e.g., loading, RSSI, etc.) associated with the channel(s).

In some scenarios, the request received at block 602 may indicate that channel measurement reporting is to be invoked in a conditional manner (e.g., an opportunistic manner). As represented by block 606, a determination as to whether to select a time to invoke channel measurement reporting based on the at least one measurement timing criterion is, in some cases, based on the type of request and/or information included in the request. For example, an indication included in the request may specify that conditional channel measurement reporting is to be based on at least one measurement timing criterion. In a similar manner as discussed above for block 406, the operations of block 606 are optional given that in various implementations conditional channel measurement reporting may be implicit, requested in some other manner, or invoked in some other way.

As represented by block 608, a time to invoke transmission of a report indicative of the measurement of the condition is selected. As discussed herein, the selection of this time is based on at least one measurement timing criterion.

A measurement timing criterion used for the invocation of the transmission of the report may take various forms. In some cases, the at least one measurement timing criterion relates to an end time for transmitting the report. In some cases, the at least one measurement timing criterion relates to a time since a last transmission of a channel measurement report by the apparatus. In some cases, the at least one measurement timing criterion relates to timing of an available time period (e.g., a contention-free period) for transmitting the report.

As represented by block 610, the transmission of the report is invoked based on the receipt of the request and further based on the time selected at block 608. Thus, upon receipt of the request at block 602, the apparatus may commence the transmission of the requested channel measurement report at the selected time. For example, invocation of channel measurement reporting may be delayed until the period of time since the last report meets or exceeds a threshold time period. As another example, invocation of the channel measurement reporting may be expedited if a reporting end time cannot otherwise be met.

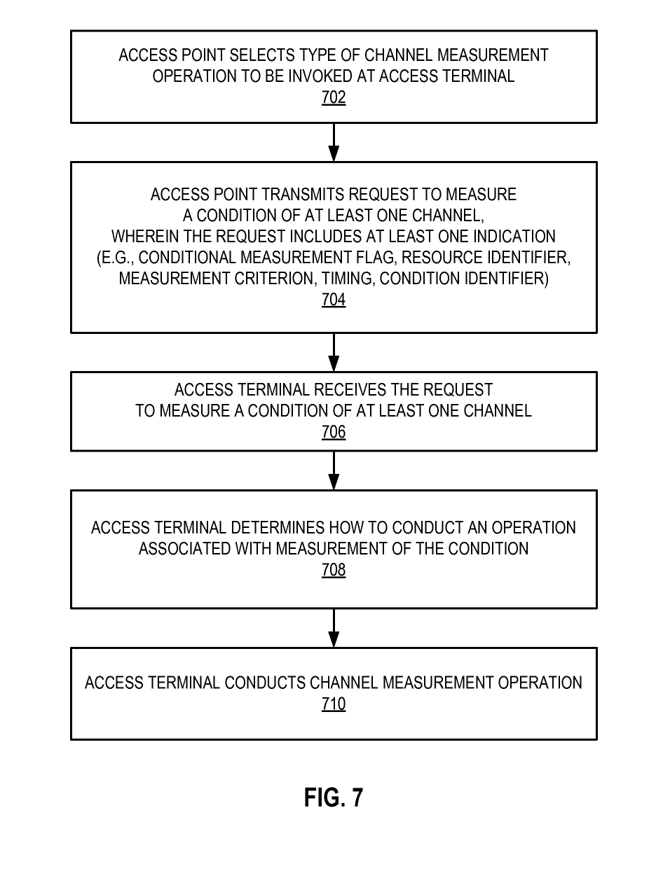

FIG. 7 relates the use of a request that includes one or more indications for invoking conditional channel measurement operations. For purposes of illustration, these operations are described as being performed by an access point (e.g., an IEEE 802.11-based AP) and an access terminal (e.g., an IEEE 802.11-based STA). It should be appreciated, however, that these operations may be performed by other types of apparatuses.

At various points in time, an access point takes action to acquire the current conditions of the channels used by that access point and/or by other access points in the vicinity of that access point. This channel information may be used by the access point, for example, to determine whether to switch to another (e.g., better) channel, to assist nearby access terminals with handover decisions, or to facilitate other operations of a wireless communication system.

As represented by block 702, the access point (e.g., a processing system of the access point) selects a type of channel measurement operation to be invoked at one or more access terminals. For example, the access point may elect to invoke a conventional (e.g., high priority) channel measurement or a conditional (e.g., opportunistic) channel measurement.

As an example of a conventional channel measurement, the access point may elect to obtain channel condition information as soon as possible. For example, the access point may have detected a decline in service (e.g., possible due to deterioration of a channel), the demand on the access point may have recently changed (e.g., as a result of higher traffic demand, as a result of serving additional access terminals, etc.). Accordingly, the access point may invoke a channel measurement that takes priority over other operations.

As an example of a conditional channel measurement, the access point may elect to mitigate the impact that channel measurement operations would otherwise have on the access point's associated access terminals. To this end, the access point may, as a default, obtain channel condition information on an as-available basis, and only invoke conventional channel measurement under certain circumstances (e.g., as discussed above). Accordingly, for normal channel information acquisition operations (e.g., performed on a regular basis), the access point may issue a channel measurement request that allows the access terminal to perform the requested operation at a more opportune time.

As represented by block 704, the access point (e.g., a transmitter of the access point) transmits a request to measure a condition of at least one channel. This request includes at least one indication that is used by an access terminal to service the request. Such an indication may take various forms.

In some cases, the at least one indication comprises a conditional (e.g., opportunistic) measurement flag. For example, the at least one indication may indicate that an operation is to be invoked based on availability of at least one resource. In such a case, the at least one indication (e.g., another indication of a plurality of indications) may specify the at least one resource. As another example, the at least one indication may indicate that an operation is to be invoked based on at least one measurement timing criterion. In such a case, the at least one indication (e.g., another indication of a plurality of indications) may specify the at least one measurement criterion.

In some cases, the at least one indication comprises timing information. For example, the at least one indication may comprise an end time for a channel measurement and/or an end time for reporting a channel measurement.

In some cases, the at least one indication specifies the type of channel condition to be measured and/or reported. For example, the at least one indication may specify that the condition to be measured comprises channel loading

As represented by block 706, the access terminal receives the request transmitted by the access point at block 704.

As represented by block 708, the access terminal determines how to conduct an operation associated with measurement of the condition. Such an operation may related to, for example, measuring a condition of a channel and/or transmitting a report indicative of the results of the measurement. Also, a determination regarding how to conduct such an operation may involve, for example, determining whether to invoke an operation, determining when to invoke an operation, determining what is to be measured and/or reported, identifying any conditions that are to be used in conjunction with invoking and/or performing an operation, and so on.

In some aspects, the determination of block 708 is based on the at least one indication included in the request. For example, as discussed herein, an indication may identify the type of request, may specify conditions to be applied in conjunction with an operation, may identify parameters to be used in conjunction with an operation, and so on.

As represented by block 710, the access terminal conducts a channel measurement operation based on the determination of block 708. Ac discussed herein, a channel measurement operation may comprise, for example, a channel measurement and/or transmission of a channel measurement report.

It should be appreciated that the operations described in FIGS. 3-7 (or elsewhere herein) may be substituted for one another and/or combined in various ways based on the teachings herein. For example, the invocation of a channel measurement operation may be based on both resource availability and at least one measurement timing criterion in some cases.

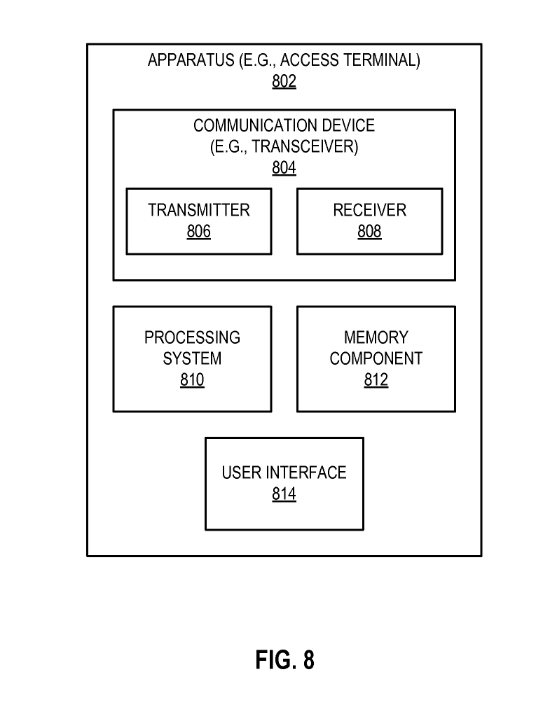

FIG. 8 illustrates several sample components (represented by corresponding blocks) that may be incorporated into an apparatus 802 (e.g., corresponding to the access terminal 102 of FIG. 1) to perform channel measurement operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other nodes in a system may include components similar to those described for the apparatus 802 to provide similar functionality. Also, a given node may contain one or more of the described components. For example, an apparatus may include multiple transceiver components that enable the apparatus to operate on multiple carriers and/or communicate via different technologies.

The apparatus 802 includes at least one wireless communication device (represented by the communication device 804) for communicating with other nodes via at least one designated radio access technology. The communication device 804 includes at least one transmitter 806 for sending signals (e.g., messages, reports, indications, information, and so on) and at least one receiver 808 for receiving signals (e.g., messages, requests, pilot signals, indications, information, and so on). A transmitter 806 and a receiver 808 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The apparatus 802 also includes other components that may be used in conjunction with channel measurement operations as taught herein. For example, the apparatus 802 includes a processing system 810 for providing functionality relating to channel measurement operations and for providing other processing functionality. Examples of such functionality include one or more of: determining availability of at least one resource; invoking a channel measurement operation (e.g., measurement of a condition and/or transmission of a report); measuring a condition of at least one channel; determining an impact of a channel measurement operation on at least one resource; determining, based on an indication included in a request, whether to invoke a channel measurement operation based on availability of at least one resource; selecting a time to invoke a channel measurement operation based on at least one measurement timing criterion; invoking a channel measurement operation based on receipt of a request and based on a selected time; determining an impact on at least one resource due to a selected time for invoking a channel measurement operation; determining, based on an indication included in a request, whether to select a time to invoke a channel measurement operation based on at least one measurement timing criterion; or determining how to conduct an operation associated with measurement of a condition. The apparatus 802 includes a memory component 812 (e.g., including a memory device) for maintaining information (e.g., information, channel condition information, channel measurement condition information, thresholds, parameters, and so on). In addition, the apparatus 802 includes a user interface device 814 for providing indications (e.g., audible and/or visual indications) to a user and/or for receiving user input (e.g., upon user actuation of a sensing device such a keypad, a touch screen, a microphone, and so on).

For convenience, the apparatus 802 is shown in FIG. 8 as including components that may be used in the various examples described herein. In practice, the illustrated blocks may have different functionality in different implementations. For example, the functionality of the block 810 may be different in an implementation based on FIG. 3 as compared to an implementation based on FIG. 4.

The components of FIG. 8 may be implemented in various ways. In some implementations, the components of FIG. 8 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 804, 810, 812, and 814 may be implemented by processor and memory component(s) of the apparatus (e.g., by execution of appropriate code and/or by appropriate configuration of processor components).

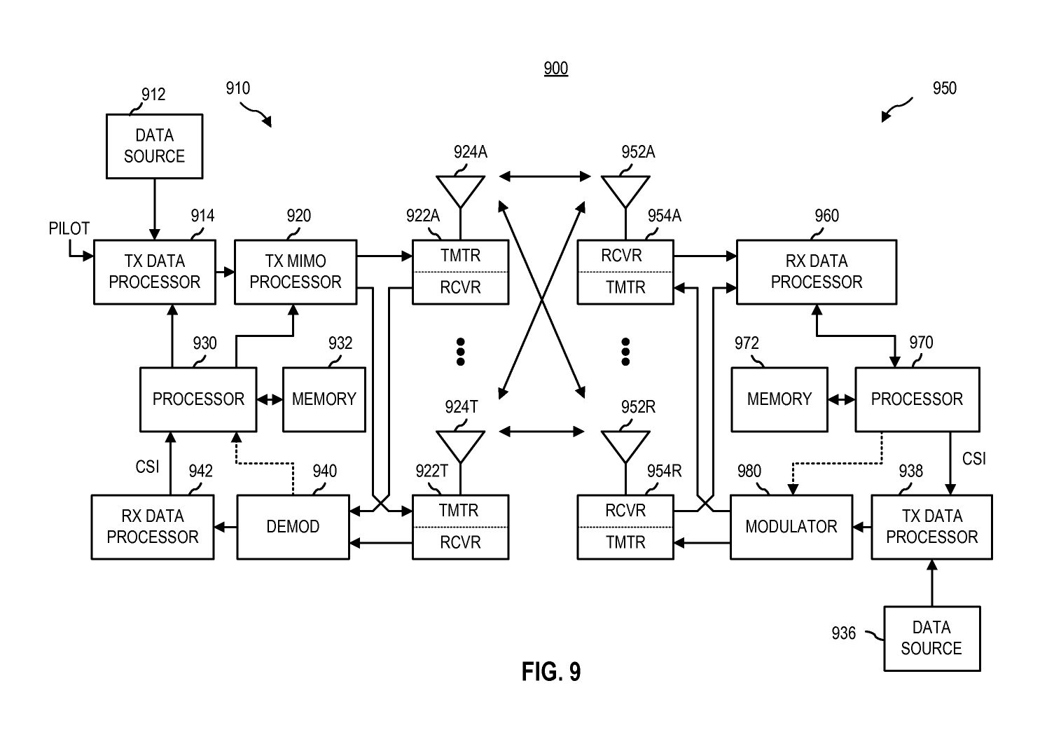

FIG. 9 illustrates in more detail sample components that may be employed in a pair of wireless nodes of a MIMO system 900. In this example, the wireless nodes are labeled as a wireless device 910 (e.g., an access point) and a wireless device 950 (e.g., an access terminal). It should be appreciated that a MU-MIMO system will include other devices (e.g., access terminals) similar to the wireless device 950. To reduce the complexity of FIG. 9, however, only one such device is shown.

The MIMO system 900 employs multiple (N_{T}) transmit antennas and multiple (N_{R}) receive antennas for data transmission. A MIMO channel formed by the N_{T} transmit and N_{R} receive antennas is decomposed into Nₛ independent channels, which are also referred to as spatial channels, where N_{S}≦min{N_{T}, N_{R}}.

The MIMO system 900 supports time division duplex (TDD) and/or frequency division duplex (FDD). In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

Referring initially to the device 910, traffic data for a number of data streams is provided from a data source 912 to a transmit (TX) data processor 914. Each data stream is then transmitted over a respective transmit antenna.

The TX data processor 914 formats, codes, and interleaves the traffic data for each data stream based on a particular coding scheme selected for that data stream to provide coded data. The coded data for each data stream is multiplexed with pilot data using OFDM techniques or other suitable techniques. The pilot data is typically a known data pattern that is processed in a known manner and used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream are typically determined by instructions performed by a processor 930. A memory 932 stores program code, data, and other information used by the processor 930 or other components of the device 910.

The modulation symbols for all data streams are then provided to a TX MIMO processor 920, which further processes the modulation symbols (e.g., for OFDM). The TX MIMO processor 920 then provides N_{T} modulation symbol streams to N_{T} transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 922A through 922T are then transmitted from N_{T} antennas 924A through 924T, respectively.

At the device 950, the transmitted modulated signals are received by N_{R} antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the N_{R} received symbol streams from N_{R} transceivers 954 based on a particular receiver processing technique to provide N_{T} “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which precoding matrix to use (discussed below). The processor 970 formulates a reverse link message comprising a matrix index portion and a rank value portion. A memory 972 stores program code, data, and other information used by the processor 970 or other components of the device 950.

The reverse link message comprises various types of information regarding the communication link and/or the received data stream. The reverse link message is processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which precoding matrix to use for determining the beamforming weights by processing the extracted message.

In some implementations, the receive data processor 960 and/or the processor 970 performs the channel measurement operations described herein. It should be appreciated that these operations may be performed in cooperation with other components of FIG. 9 and/or by other components of FIG. 9 in some implementations.

A wireless node may include various components that perform functions based on signals that are transmitted by or received at the wireless node. For example, in some implementations a wireless node comprises a user interface configured to output an indication based on a received signal as taught herein.

A wireless node as taught herein may communicate via one or more wireless communication links that are based on or otherwise support any suitable wireless communication technology. For example, in some aspects a wireless node may associate with a network such as a local area network (e.g., a Wi-Fi network) or a wide area network. To this end, a wireless node may support or otherwise use one or more of a variety of wireless communication technologies, protocols, or standards such as, for example, Wi-Fi, WiMAX, CDMA, TDMA, OFDM, and OFDMA. Also, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a wireless node comprises an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless node also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Re10, RevA, RevB) technology and other technologies.

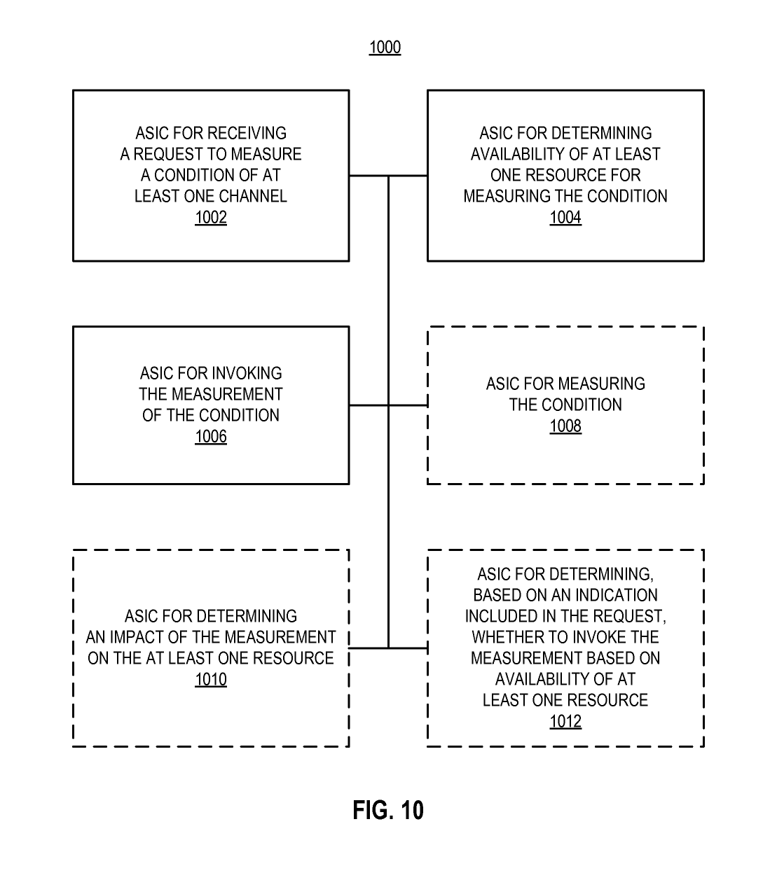

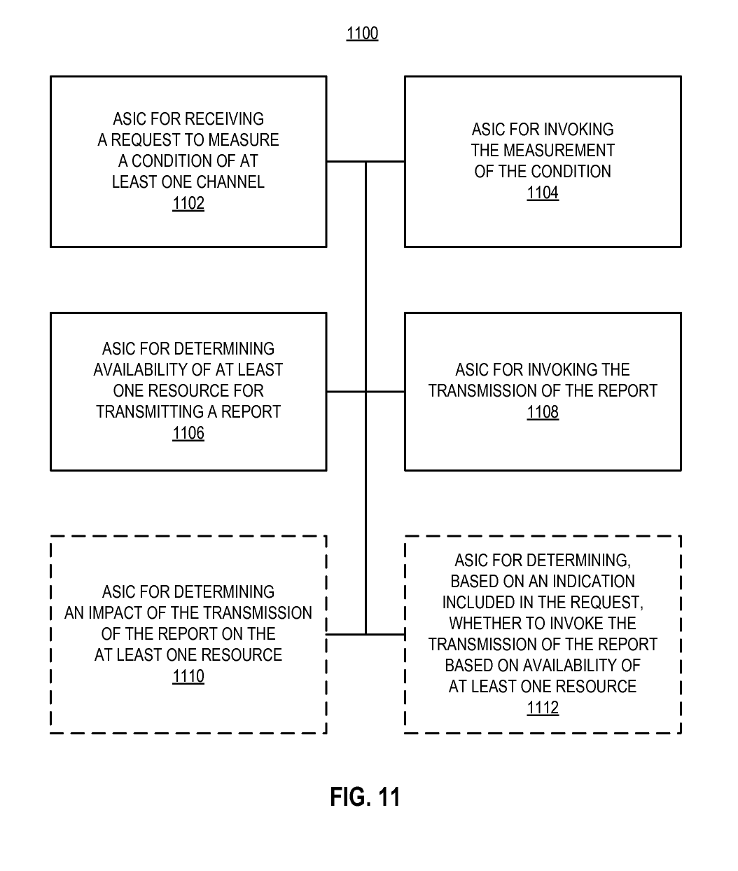

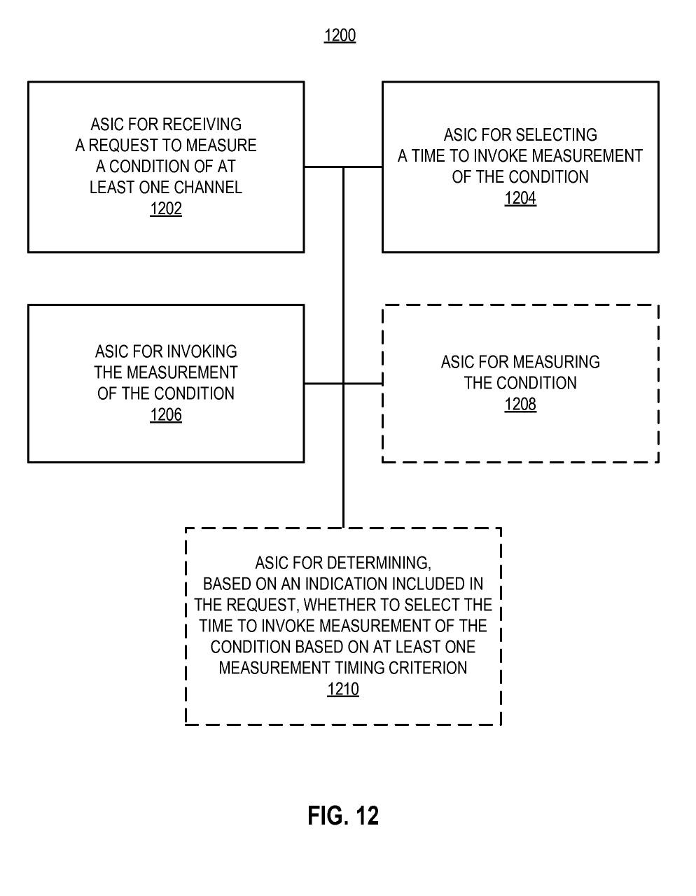

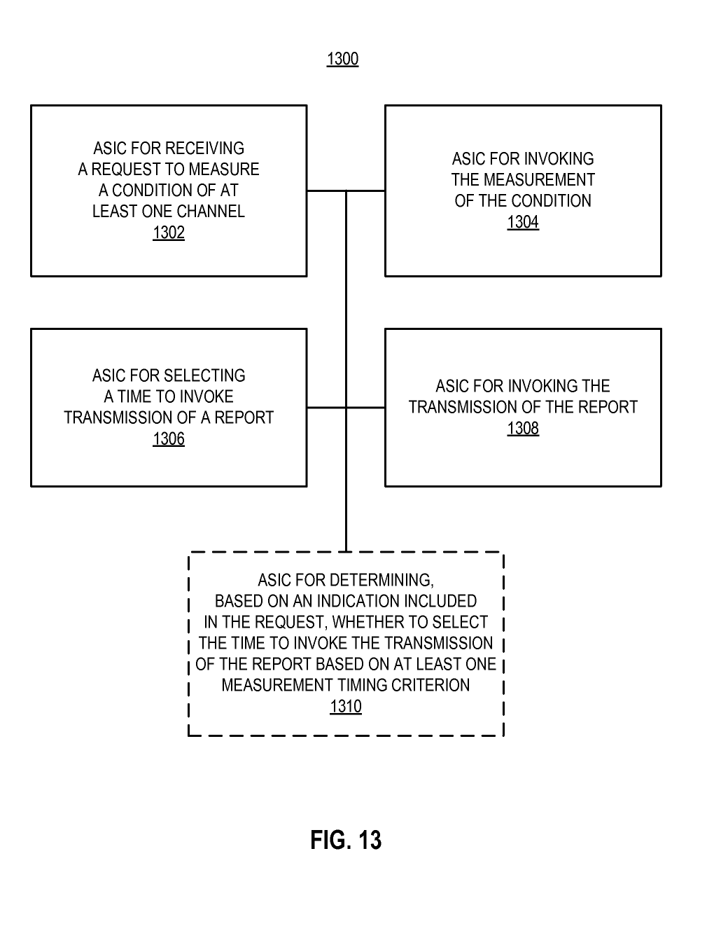

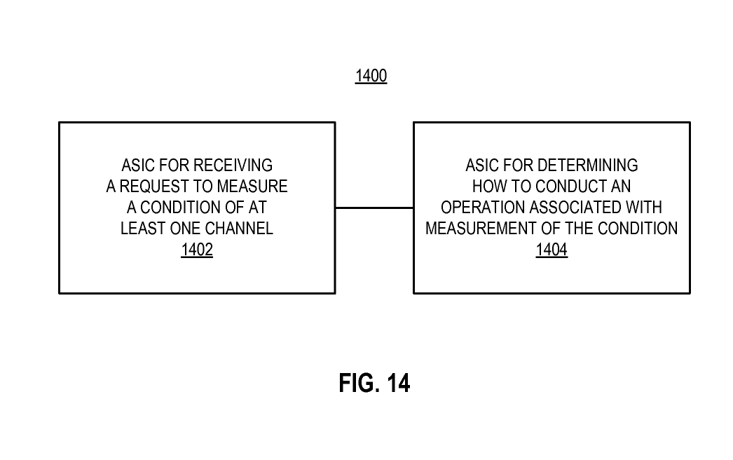

The components described herein may be implemented in a variety of ways. Referring to FIGS. 10, 11, 12, 13, and 14, apparatuses 1000, 1100, 1200, 1300, and 1400 are represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1000 includes one or more modules that may perform one or more of the functions described above with regard to various figures. For example, an ASIC for receiving a request to measure a condition of at least one channel 1002 may correspond to, for example, a receiver (e.g., an RF receive chain circuit) as discussed herein. An ASIC for determining availability of at least one resource for measuring the condition 1004 may correspond to, for example, a processing system as discussed herein. An ASIC for invoking the measurement of the condition 1006 may correspond to, for example, a processing system as discussed herein. An ASIC for measuring the condition 1008 may correspond to, for example, a processing system as discussed herein. An ASIC for determining an impact of the measurement on the at least one resource 1010 may correspond to, for example, a processing system as discussed herein. An ASIC for determining, based on an indication included in the request, whether to invoke the measurement based on availability of at least one resource 1012 may correspond to, for example, a processing system as discussed herein.

The apparatus 1100 includes one or more modules that may perform one or more of the functions described above with regard to various figures. For example, an ASIC for receiving a request to measure a condition of at least one channel 1102 may correspond to, for example, a receiver as discussed herein. An ASIC for invoking the measurement of the condition 1104 may correspond to, for example, a processing system as discussed herein. An ASIC for determining availability of at least one resource for transmitting a report 1106 may correspond to, for example, a processing system as discussed herein. An ASIC for invoking the transmission of the report 1108 may correspond to, for example, a processing system as discussed herein. An ASIC for determining an impact of the transmission of the report on the at least one resource 1110 may correspond to, for example, a processing system as discussed herein. An ASIC for determining, based on an indication included in the request, whether to invoke the transmission of the report based on availability of at least one resource 1112 may correspond to, for example, a processing system as discussed herein.

The apparatus 1200 also includes one or more modules that may perform one or more of the functions described above with regard to various figures. For example, an ASIC for receiving a request to measure a condition of at least one channel 1202 may correspond to, for example, a receiver as discussed herein. An ASIC for selecting a time to invoke measurement of the condition 1204 may correspond to, for example, a processing system as discussed herein. An ASIC for invoking the measurement of the condition 1206 may correspond to, for example, a processing system as discussed herein. An ASIC for measuring the condition 1208 may correspond to, for example, a processing system as discussed herein. An ASIC for determining, based on an indication included in the request, whether to select the time to invoke measurement of the condition based on at least one measurement timing criterion 1210 may correspond to, for example, a processing system as discussed herein.

The apparatus 1300 also includes one or more modules that may perform one or more of the functions described above with regard to various figures. For example, an ASIC for receiving a request to measure a condition of at least one channel 1302 may correspond to, for example, a receiver as discussed herein. An ASIC for invoking the measurement of the condition 1304 may correspond to, for example, a processing system as discussed herein. An ASIC for selecting a time to invoke transmission of a report 1306 may correspond to, for example, a processing system as discussed herein. An ASIC for invoking the transmission of the report 1308 may correspond to, for example, a processing system as discussed herein. An ASIC for determining, based on an indication included in the request, whether to select the time to invoke the transmission of the report based on at least one measurement timing criterion 1310 may correspond to, for example, a processing system as discussed herein.

The apparatus 1400 also includes one or more modules that may perform one or more of the functions described above with regard to various figures. For example, an ASIC for receiving a request to measure a condition of at least one channel 1402 may correspond to, for example, a receiver as discussed herein. An ASIC for determining how to conduct an operation associated with measurement of the condition 1404 may correspond to, for example, a processing system as discussed herein.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof Also, it should be appreciated that a given subset (e.g., of an integrated circuit and/or of a set of software modules) may provide at least a portion of the functionality for more than one module. In some aspects one or more of any components represented by dashed boxes are optional.

The apparatuses 1000-1400 comprise one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 1000 may comprise a single ASIC (with components 1002-1012 comprising different sections of the ASIC). As another specific example, the apparatus 1000 may comprise several ASICs (e.g., with the component 1002 comprising one ASIC and the components 1004-1012 comprising another ASIC).

In addition, the components and functions represented by FIGS. 10-14 as well as other components and functions described herein, may be implemented using any suitable means. Such means are implemented, at least in part, using corresponding structure as taught herein. For example, the components described above in conjunction with the “ASIC for” components of FIGS. 10 - 14 correspond to similarly designated “means for” functionality. Thus, one or more of such means is implemented using one or more of processor components, integrated circuits, or other suitable structure as taught herein in some implementations. Several examples follow. In some aspects, means for receiving comprises a receiver. In some aspects, means for determining comprises a processing system. In some aspects, means for invoking comprises a processing system. In some aspects, means for measuring comprises a processing system. In some aspects, means for selecting comprises a processing system.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Those of skill in the art understand that information and signals may be represented using any of a variety of different technologies and techniques. For example, any data, instructions, commands, information, signals, bits, symbols, and chips referenced throughout the above description may be represented by voltages, currents, electromagnetic waves, magnetic fields or particles, optical fields or particles, or any combination thereof

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code executable (e.g., executable by at least one computer) to provide functionality relating to one or more of the aspects of the disclosure. In some aspects, a computer program product may comprise packaging materials.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for wireless communication, comprising:
a receiver configured to receive a request to measure a condition of at least one channel; and
a processing system configured to:
determine availability of at least one resource for measuring the condition of the at least one channel, and
invoke the measurement of the condition based on the receipt of the request and further based on the availability of the at least one resource.

2. The apparatus of claim 1, wherein the determination of the availability of the at least one resource comprises determining an amount of data traffic expected to be received by the apparatus.

3. The apparatus of claim 1, wherein the determination of the availability of the at least one resource comprises determining an amount of data traffic expected to be transmitted by the apparatus.

4. The apparatus of claim 1, wherein the availability of the at least one resource relates to availability of a battery resource of the apparatus.

5. The apparatus of claim 1, wherein the condition of the at least one channel comprises channel loading.

6. The apparatus of claim 1, wherein:
the processing system is further configured to determine an impact of the measurement on the at least one resource; and
the invocation of the measurement is further based on the determined impact.

7. A method of wireless communication, comprising:
receiving, by an apparatus, a request to measure a condition of at least one channel;
determining, by the apparatus, availability of at least one resource for measuring the condition of the at least one channel; and
invoking, by the apparatus, the measurement of the condition based on the receipt of the request and further based on the availability of the at least one resource.

8. The method of claim 7, wherein the determination of the availability of the at least one resource comprises determining an amount of data traffic expected to be received by the apparatus.

9. The method of claim 7, wherein the determination of the availability of the at least one resource comprises determining an amount of data traffic expected to be transmitted by the apparatus.

10. The method of claim 7, wherein the availability of the at least one resource relates to availability of a battery resource of the apparatus.

11. The method of claim 7, wherein the condition of the at least one channel comprises channel loading.

12. The method of claim 7, further comprising determining an impact of the measurement on the at least one resource, wherein the invocation of the measurement is further based on the determined impact.

13. An apparatus for wireless communication, comprising:
means for receiving a request to measure a condition of at least one channel;
means for determining availability of at least one resource for measuring the condition of the at least one channel; and
means for invoking the measurement of the condition based on the receipt of the request and further based on the availability of the at least one resource.

14. The apparatus of claim 13, wherein the determination of the availability of the at least one resource comprises determining an amount of data traffic expected to be received by the apparatus.

15. The apparatus of claim 13, wherein the determination of the availability of the at least one resource comprises determining an amount of data traffic expected to be transmitted by the apparatus.

16. The apparatus of claim 13, wherein the availability of the at least one resource relates to availability of a battery resource of the apparatus.

17. The apparatus of claim 13, wherein the condition of the at least one channel comprises channel loading.

18. The apparatus of claim 13, further comprising means for determining an impact of the measurement on the at least one resource, wherein the invocation of the measurement is further based on the determined impact.

19. A computer-program product, comprising:
computer-readable medium comprising code executable to:
receive, by an apparatus, a request to measure a condition of at least one channel;
determine, by the apparatus, availability of at least one resource for measuring the condition of the at least one channel; and
invoke, by the apparatus, the measurement of the condition based on the receipt of the request and further based on the availability of the at least one resource.

20. An access terminal, comprising:
an antenna;
a receiver configured to receive, via the antenna, a request to measure a condition of at least one channel; and
a processing system configured to:
determine availability of at least one resource for measuring the condition of the at least one channel, and
invoke the measurement of the condition based on the receipt of the request and further based on the availability of the at least one resource.

21. An apparatus for wireless communication, comprising:
a receiver configured to receive a request to measure a condition of at least one channel; and
a processing system configured to:
invoke the measurement of the condition of the at least one channel, determine availability of at least one resource for transmitting a report indicative of the measurement of the condition, and
invoke the transmission of the report based on the receipt of the request and further based on the availability of the at least one resource.

22. The apparatus of claim 21, wherein the availability of at least one resource relates to availability of a scheduled data frame transmission for piggybacking of the report.

23. The apparatus of claim 21, wherein the availability of at least one resource relates to availability of a contention-free time for transmitting the report.

24. The apparatus of claim 21, wherein the availability of the at least one resource relates to availability of a battery resource of the apparatus.

25. The apparatus of claim 21, wherein the determination of the availability of at least one resource comprises determining loading on a channel used by the apparatus.

26. The apparatus of claim 21, wherein the availability of at least one resource relates to availability of a period of time for transmitting the report.

27. The apparatus of claim 21, wherein the condition of the at least one channel comprises channel loading.

28. The apparatus of claim 21, wherein:
the processing system is further configured to determine an impact of the transmission of the report on the at least one resource; and
the invocation of the transmission of the report is further based on the determined impact.

29. A method of wireless communication, comprising:
receiving, by an apparatus, a request to measure a condition of at least one channel;
invoking, by the apparatus, the measurement of the condition of the at least one channel;
determining, by the apparatus, availability of at least one resource for transmitting a report indicative of the measurement of the condition; and
invoking, by the apparatus, the transmission of the report based on the receipt of the request and further based on the availability of the at least one resource.

30. The method of claim 29, wherein the availability of at least one resource relates to availability of a scheduled data frame transmission for piggybacking of the report.

31. The method of claim 29, wherein the availability of at least one resource relates to availability of a contention-free time for transmitting the report.

32. The method of claim 29, wherein the availability of the at least one resource relates to availability of a battery resource of the apparatus.

33. The method of claim 29, wherein the determination of the availability of at least one resource comprises determining loading on a channel used by the apparatus.

34. The method of claim 29, wherein the availability of at least one resource relates to availability of a period of time for transmitting the report.

35. The method of claim 29, wherein the condition of the at least one channel comprises channel loading.

36. The method of claim 29, further comprising determining an impact of the transmission of the report on the at least one resource, wherein the invocation of the transmission of the report is further based on the determined impact.

37. An apparatus for wireless communication, comprising:
means for receiving a request to measure a condition of at least one channel;
means for invoking the measurement of the condition of the at least one channel;
means for determining availability of at least one resource for transmitting a report indicative of the measurement of the condition; and
means for invoking the transmission of the report based on the receipt of the request and further based on the availability of the at least one resource.

38. The apparatus of claim 37, wherein the availability of at least one resource relates to availability of a scheduled data frame transmission for piggybacking of the report.

39. The apparatus of claim 37, wherein the availability of at least one resource relates to availability of a contention-free time for transmitting the report.

40. The apparatus of claim 37, wherein the availability of the at least one resource relates to availability of a battery resource of the apparatus.

41. The apparatus of claim 37, wherein the determination of the availability of at least one resource comprises determining loading on a channel used by the apparatus.

42. The apparatus of claim 37, wherein the availability of at least one resource relates to availability of a period of time for transmitting the report.

43. The apparatus of claim 37, wherein the condition of the at least one channel comprises channel loading.

44. The apparatus of claim 37, further comprising means for determining an impact of the transmission of the report on the at least one resource, wherein the invocation of the transmission of the report is further based on the determined impact.

45. A computer-program product, comprising:
computer-readable medium comprising code executable to:
receive, by an apparatus, a request to measure a condition of at least one channel;
invoke, by the apparatus, the measurement of the condition of the at least one channel;
determine, by the apparatus, availability of at least one resource for transmitting a report indicative of the measurement of the condition; and
invoke, by the apparatus, the transmission of the report based on the receipt of the request and further based on the availability of the at least one resource.

46. An access terminal, comprising:
an antenna;
a receiver configured to receive, via the antenna, a request to measure a condition of at least one channel; and
a processing system configured to:
invoke the measurement of the condition of the at least one channel,
determine availability of at least one resource for transmitting a report indicative of the measurement of the condition, and
invoke the transmission of the report based on the receipt of the request and further based on the availability of the at least one resource.
